(19) United States
(12) Patent Application Publication
(10) Pub. No.: US 2005/0271049 A1
(43) Pub. Date: Dec. 8, 2005

(54) DHCP cache method and apparatus

(75) Inventors: Vinit Jain, Austin, TX (US); Alexander Medvedev, Austin, TX (US); Vasu Vallabhaneni, Austin, TX (US); Patrick Tam Vo, Houston, TX (US)

Correspondence Address: Kelly K. Kordzik, P.O. Box 50784, Dallas, TX, 75201, US

(73) Assignee: International Business Machines Corporation, Armonk, NY (US)

(21) Appl. No.: 10/860,298

(22) Filed: Jun. 3, 2004

(51) Int. Cl. H04L 12/56

(52) U.S. Cl. 370/389

(57) ABSTRACT

The invention relates to a router that keeps a short-lived cache of DHCP packets. Each time the router receives a DHCP request or discover packet, the router checks to see if the packet is already in the cache. If the packet is in the cache and has already been processed, the router will discard or ignore the duplicate packet.

### TECHNICAL FIELD

The present invention relates in general to data processing systems, and in particular to the caching of request messages sent by clients through relay agents to Dynamic Host Control Protocol (DHCP) servers.

### BACKGROUND INFORMATION

Computers can connect to each other over networks and over the Internet using TCP/IP protocol. TCP/IP stands for Transmission Control Protocol/Internet Protocol, which is a family of networking protocols providing communication across interconnected networks, between computers with diverse hardware architectures, and between various computer operating systems.

Network communication using TCP/IP typically requires each device on the network to have a unique IP address. An IP address is a unique, 32-bit identifier for a specific TCP/IP computer on a network, such as the Internet. IP addresses are also referred to as Internet Addresses. However, IP addresses are used for communications within networks smaller than the Internet. Current IP addresses are in dotted decimal form, such as 111.123.09.191, with each of the four address fields assigned as many as 255 values. The IP address is a “structured” address that contains both network and device information.

Dynamic Host Control Protocol (DHCP) is an open, industry standard protocol that reduces the complexity of administering networks based on TCP/IP. Each host computer connected to a TCP/IP network must be assigned a unique IP address. Prior to DHCP servers, if a network was to be attached to the Internet, the network administer would obtain a unique network ID and ensure that IP addresses on the assigned network were unique. On a large network, this was a difficult problem. DHCP provided a solution by having a DHCP server assign an IP address to a DHCP client when the client computer initialized. Therefore, DHCP allowed for the addition of a new computer to a network without bothering a network administrator to manually assign a unique IP address.

Another advantage of DHCP is that it enables time-sharing of network resources. In other words, DHCP allows for a limited number of IP addresses assigned to a network to be used for a greater number of computers. Such address pooling is more efficient than having dedicated IP addresses for each client. DHCP is useful whether a client is connecting to the Internet or a much smaller network such as a LAN.

Like its predecessor, the Bootstrap Protocol (Bootp), DHCP supports manual, automatic and dynamic address assignment and is routable. With dynamic addressing, a device can have a different IP address every time it connects to the network. In some systems, the device's IP address could even change while it is still connected. DHCP also supports a mix of static and dynamic IP addresses.

When a DHCP-enabled client computer boots, it broadcasts a message requesting information with which to configure its network interface so that the TCP/IP protocol stack can be used for communication. DHCP servers receive the message from the client and send replies that contain the request configuration information. The essential pieces of information that must be supplied by the DHCP server include an IP address and a subnet mask.

DHCP operations typically fall into four basic phases. The first phase is IP lease request. When a client computer is booted or comes on-line to a network, the client computer checks to see if it has an IP address leased. If it does not have an IP address leased, the client computer requests a lease from a DHCP server. Because the client computer does not know the address of a DHCP server, the client computer broadcasts a DHCP-DISCOVER packet across the network.

A client might use DHCP to reacquire or verify its IP address and network parameters whenever the local network parameters may have changed, e.g., at system boot time or after a disconnection from the local network, as the local network configuration may change without the client's or user's knowledge.

The second phase of DHCP operation involves the lease offer. When a DHCP server receives an IP lease request from a client computer, the DHCP extends an IP lease offer. IP lease offers are extended by reserving an IP address for the client computer and broadcasting a DHCP-OFFER packet across the network.

The third phase of DHCP operation is for the client to inform servers that the client has accepted an IP lease offer. When the client computer receives the IP lease offer, the client computer sends a DHCP-REQUEST packet over the network to inform all the other DHCP servers that it has accepted an offer. When the other DHCP servers receive this message, the DHCP servers withdraw any offers that they might have made to the client computer and return unused addresses back to the pool of valid addresses available. Any number of DHCP servers could respond to an IP lease request, but the client computer can only accept one offer per network interface card.

When the DHCP server receives the DHCP-REQUEST packet from the client computer, the DHCP server initiates the final phase of the DHCP operation. This acknowledgement phase involves sending a DHCP-ACK packet to the client computer. This packet includes the lease duration and any other configuration information that the client might have requested. At this point, the TCP/IP configuration process is complete.

Using DHCP relays, it is possible for one DHCP server to provide IP addresses to clients on more than one network. DHCP relays provide the mechanism for relaying requests for DHCP service between networks or subnets. If one DHCP server is not available on a subnet or network, the DHCP relay agent will relay a request for configuration from a DHCP client to a DHCP server on another subnet or network.

The term “failover” can be used to describe a backup operation that automatically switches to a standby system if the primary system fails or is temporarily shut down for servicing. Failover could also describe the function of a relay agent receiving packets from multiple, redundant interfaces. Failover serves an important redundancy function for systems that rely on constant accessibility. A user is normally unaware when a failover system automatically redirects a user request from the unavailable system to the backup system or when a failover system sends information over multiple paths. One of the methods that is used in the industry is to have a router which has more than one interface on the same subnet. If one of the interfaces goes down the router can forward packets using the other interface.

Many DHCP clients are not resident on the same network segment as a DHCP server. In order to support this form of network architecture, many contemporary routers implement something known as a Bootp relay agent. This capability inside of a router listens for all broadcasts at the DHCP port, port 67, and will relay any broadcasts that it receives to a DHCP server. The IP address of the DHCP server is normally configured into the router. As part of the relay process, the relay agent will place the address of the interface on which it received the broadcast into a specific field of the DHCP packet. A Bootp relay agent on a router may be configured to receive packets from more than one interface and configured to send packets to more than one DHCP server. Most Bootp relay agent implementations allow this duplication of packets.

DHCP uses User Datagram Protocol (UDP) as its transport protocol. In TCP/IP and UDP networks, a port could be any endpoint to a logical connection. A port number typically identifies what type of port it is. DHCP messages from a client to a server are normally sent to the ‘DHCP server’ port 67, and DHCP messages from a server to a client are normally sent to the ‘DHCP client’ port 68. In other words, port 67 is the port a Bootp/DHCP server listens on and port 68 is the port the Bootp/DHCP server sends out information on.

The term interface could describe the wires, plugs, channels, wireless channels, sockets, and the like that hardware devices use to communicate with each other. For purposes of failover and/or redundancy, a network transmits packets to relay agents and routers through more than one interface. When a client transmits a DHCP broadcast packet, a router operating in failover mode typically receives the packet multiple on interfaces between a subnet and the router. Often, the relay agent treats a duplicate packet received over multiple interfaces as a separate packet in need of forwarding. In forwarding such duplicate packets, a router may perform extra work. Further, if the DHCP server sends a response to each redundant packet, the router may unnecessarily use resources to process the duplicate response. This situation related to duplicate packets can put an extra load on the DHCP server, router, and other associated software and hardware which handle DHCP packets.

What is needed is a method and apparatus for eliminating the processing and forwarding of duplicate DHCP packets.

### SUMMARY OF THE INVENTION

The invention relates to a method for assigning IP addresses comprising sending a DHCP message through one or more interfaces to a relay agent. The relay agent compares the message to stored DCHP messages and forwards the message only if the message does not match a stored DHCP message. The relay agent could be coupled to a bridge, router, or any other relay agent known in the art. The invention further relates to storing DHCP messages in a cache for comparing to future received request messages. If the relay agent determines that a DHCP message is a duplicate message, the relay agent silently discards or ignores the duplicate message.

The invention further relates to a router employing a plurality of interface connections to a first network coupled to a client. The router is coupled to a cache for storing DHCP packet information received from the client and a comparator for determining whether a DHCP packet is a duplicate DHCP packet. The DHCP packet may be a DHCP discover packet, a DHCP request packet, or other such requests sent from clients over networks as is commonly known in the art.

The invention relates to a method and apparatus for coupling to a router a cache for storing DHCP message information. When a router receives a DHCP/Bootp message, the router checks the cache to see whether the message has already been forwarded. If the message or a reference to the message is not in the cache, the router processes the message and relays the message to the DHCP server. If the message is found in the cache and deemed a duplicate, the message is ignored or silently discarded. The method and apparatus of the present invention will lessen the burden on the router and DHCP server by eliminating duplicate messages.

### BRIEF DESCRIPTION OF THE DRAWINGS

For a better understanding of the invention, an exemplary embodiment is described below, considered together with the accompanying drawings, in which:

FIG. 1 is a diagram of typical interaction between client and server;

FIG. 2 is a more detailed diagram of typical interactions between client and server;

FIG. 3 represents a simplified diagram of client-server architecture through a router;

FIG. 4 is a flow diagram illustrating an embodiment of the present invention;

FIG. 5 shows the format of a DHCP message based on the format of Bootp messages; and

FIG. 6 shows a block diagram of a relay agent relating to the present invention.

### DETAILED DESCRIPTION

In the following description, numerous specific details are set forth such as specific display configurations, etc. to provide a thorough understanding of the present invention. In other instances, well-known circuits have been shown in block diagram form in order not to obscure the present invention in unnecessary detail. Some details have been omitted as not necessary to obtain a complete understanding of the present invention because such details are within the skills of persons of ordinary skill in the relevant art. However, it will be obvious to those skilled in the art that the present invention may be practiced without providing such specific details herein.

The present invention relates to a method and apparatus for keeping a cache of recent Dynamic Host Configuration Protocol (DHCP) messages relayed by a router, bridge, or other such device. When the router receives a DHCP packet, the router checks the cache to see whether the packet has already been forwarded. If a reference to the DHCP packet is not in the cache, the router relays the packet to the DHCP server. If the packet is deemed a duplicate upon reference to the cache, the duplicate packet is ignored or silently discarded. The method and apparatus of the present invention will lighten the burden on routers and DHCP servers by eliminating the relaying of duplicate packets. Typical applications for the present invention include routers, bridges, and other such hardware and software devices.

A router could be any device (or a software product) that connects to at least two networks and decides which way to send information packets. A typical router creates or maintains a table of available routes and their conditions and uses the information to determine the best route for a given packet. A software router could be any system level function that directs a call to an application.

A router could be any interface between two networks. For instance, routers could connect LANs (Local Area Networks) to LANs or other types of networks such as MANs (Metropolitan Area Networks) or WANs (Wide Area Networks). Routers are typically protocol sensitive but support multiple protocols.

A bridge could be any piece of hardware that connects one network to another network, such as one Local Area Network (LAN) to another Local Area Network. The function of a bridge includes isolating two network segments or networks. Bridges also help to manage traffic on larger networks. Types of networks that could be connected by bridges include Ethernet, Token Ring and others.

A client/server network architecture involves the central control of network resources and data between clients and servers. The server could be any device or software that stores data files, manages access to them, and sends the information over a network when a client requests the information.

A server could be any computer or device on a network that manages network resources. For example, a file server stores files, a print server manages one or more printers, and a network server is a computer that manages network traffic. A database server is a computer system that processes database queries. Servers are often dedicated, meaning that they perform no other tasks besides their server tasks. However, a server could be a subsystem within one computer. For instance, on multiprocessing operating systems a single computer could execute several programs at once. A server in such a system could be the program that is managing resources. A DHCP server could be any hardware or software responsible for managing Internet Protocol (IP) addresses in a networked environment.

A client could be an application that runs on a computer workstation and relies on a server to perform some operations. For example, an e-mail client is an application that enables sending and receiving e-mail. A client could also be a computer or an associated operating system connected to a network.

Refer now to the drawings wherein depicted elements are not necessarily shown to scale and wherein like or similar elements are designated by the same reference numeral through the several views.

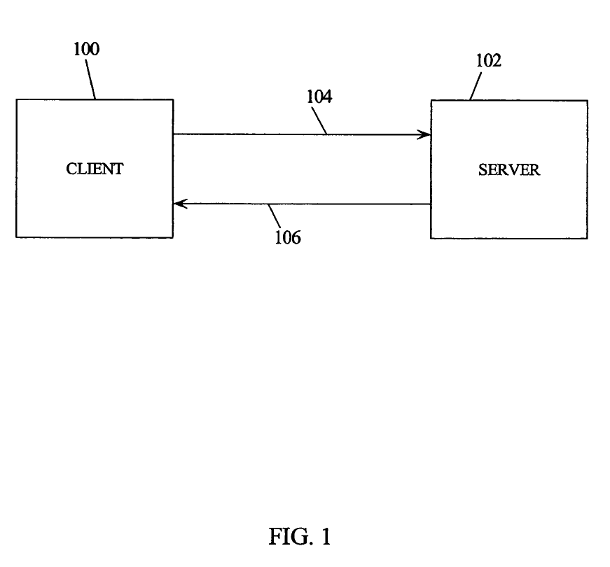

FIG. 1 illustrates a client-server configuration. Client 100 sends a message 104 to server 102. In response, server 102 sends a response 106 to client 100. Message 104 and response 106 may be sent by client and server as information packets over a network.

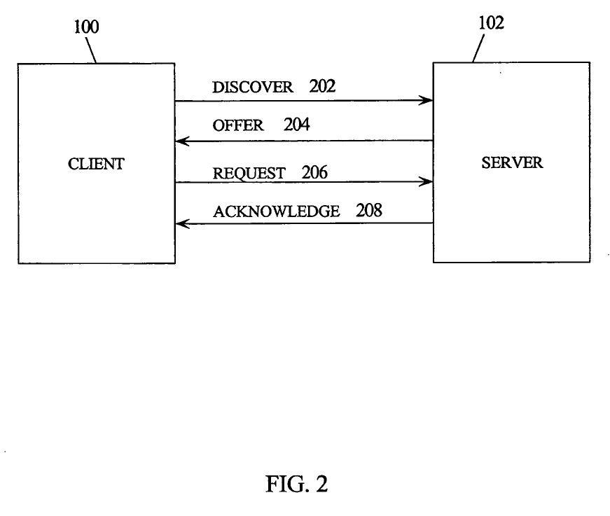

FIG. 2 illustrates a more detailed view of a client-server based interaction. At boot-up or the expiration of an IP address, client 100 sends a discover packet 202 to server 102 requesting an IP address. In response, server 102 sends an offer packet 204 to client 100. Offer 204 represents an IP lease offer of a specific IP address for a limited amount of time. When client 100 receives the offer packet 204, the client sends a request packet 206 over the network to inform the server 102 that it has accepted the offer. When the server 102 receives the request packet 206 from client 100, server 102 initiates the final phase of the configuration process. This final phase involves sending an acknowledgement packet 208 to client 100. Acknowledgement 208 includes the lease duration and any other configuration that client 100 may need. At this point, the TCP/IP configuration process is complete.

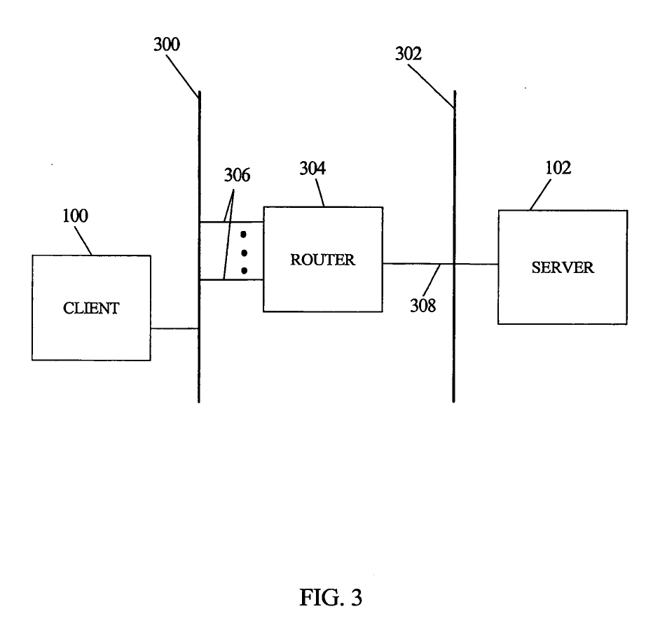

FIG. 3 represents a simplified version of client-server architecture to illustrate a view of how a client and server could communicate through a router and through various interfaces. A network arrangement might include numerous other networks, interfaces, and routers, to allow fail-safe operation of a complex network. Client 100, not knowing where server 102 is on a networked system, sends a message 104 out across network 300. Because message 104 travels over multiple interfaces 306 to router 304, router 304 must handle duplicate messages. In the prior art, router 304 would forward duplicate messages through network 302 to server 102. Such sending of duplicate messages by router 304 resulted in higher network traffic on network 302 and a higher burden on server 102. What is needed is a method and apparatus to eliminate the forwarding of such duplicate messages.

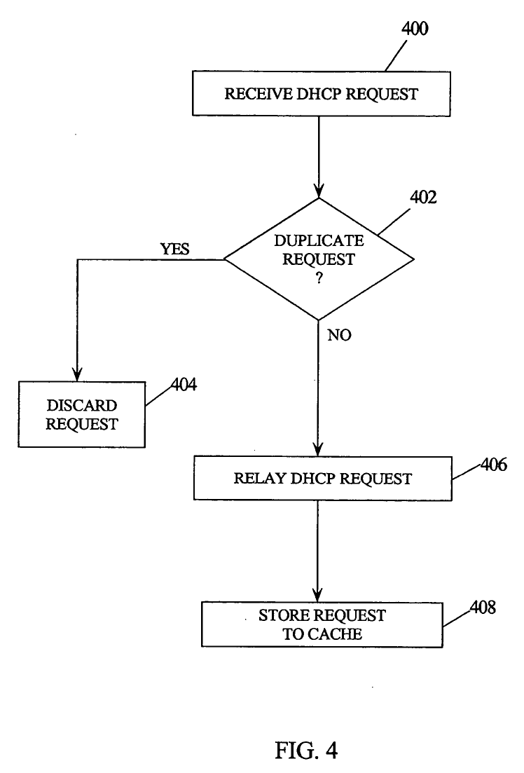

FIG. 4 shows steps carried out by an embodiment of the present invention. When router 304 receives 400 a message 104 from client 100, router 304 decides 402 whether message 104 is a duplicate message. If message 104 is a duplicate message, router 304 discards or ignores message 104 and does not forward message 104 to server 102. If message 104 is not a duplicate message, the router 304 relays 406 message 104 through network 302 to server 102. Also, router 304 stores 408 the message 104 or associated information to cache for comparison to future messages.

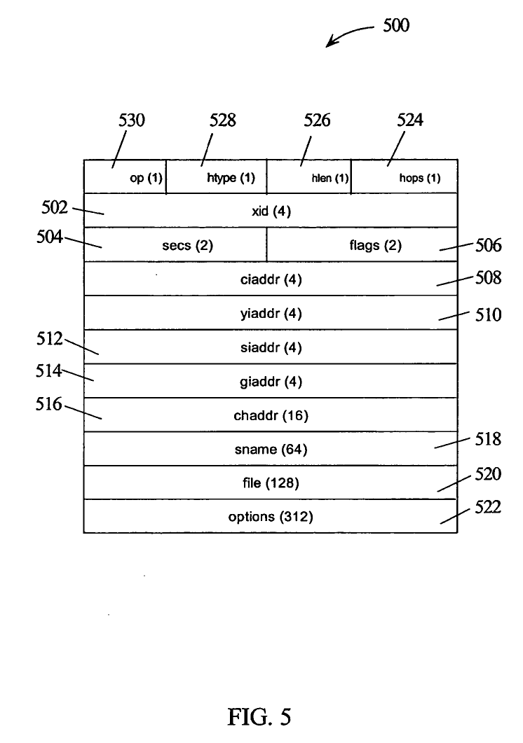

Packets sent over networks can be sent with headers and footers identifying the packets. A DHCP message could be sent with a header formatted as shown in FIG. 5. FIG. 5 shows a DHCP message header 500 and the associated fields 502-530 in the message. Field 502 is normally a random number chosen by the client 100 and used by the client 100, server 102, router 304, and other hardware or software for identifying the request packet. Other fields in DHCP message 500 include 504 which is the amount of time passed since client began the request process, field-506 which contains flags, field 508 which is the client IP address filled in by the client if the client knows its IP address, field 510 which is an IP address, field 512 which is the server IP address, field 514 which is the relay agent IP address, field 516 which is a client hardware address, field 518 which is an optional server host name, field 520 which is a boot filename, and field 522 which is an optional parameters field.

An embodiment of the present invention could use transaction ID field 502 in determining 402 whether a packet is a duplicate. The embodiment could compare the transaction ID field 502 of a message 104 to values stored in a cache. If the transaction ID field 502 matches a value found in cache, message 104 would be deemed a duplicate and router 304 would not forward the duplicate request packet.

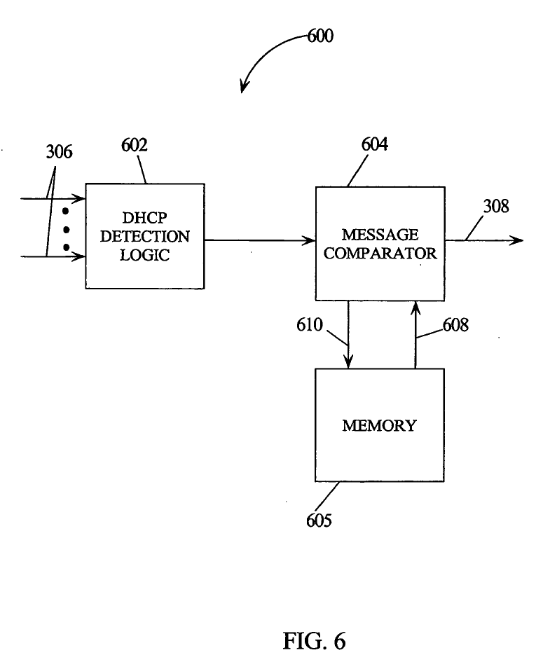

FIG. 6 is a block diagram of a relay agent related to the present invention. The relay agent could be coupled to a router or bridge or other network device for forwarding network traffic between and across networks. For instance, relay agent 600 could be coupled to router 304 to together execute the steps shown in FIG. 4.

Still referring to FIG. 6, detection logic 602 receives message 104 over multiple interfaces 306. Detection logic 602 listens for DHCP requests on port 67. Detection logic 602 forwards DHCP requests to comparator 604. Forwarding the request may occur using hardware, software, by the comparator 604 merely accessing memory, or by other means. Comparator 604 receives message 104 and accesses cache memory 606 to determine whether message 104 is a duplicate packet. If the message is not a duplicate, comparator 604 forwards message 104 over line 308 to the DHCP server. Line 308 is used for illustration purposes and its function can be accomplished through software, hardware, a memory access or any other event that provides the DHCP server with access to message 104. Also, comparator 604 stores message identifier 502 to cache for comparisons to future message identifiers.

An embodiment of the present invention deletes stored identifiers from memory 606 after a timeout period. A timeout period could be any length of time deemed adequate ranging from fractions of a second to several seconds or even longer. For instance, after a stored identifier has been in memory 606 for two seconds, the identifier could be deleted or flagged to permit forwarding of what otherwise might be deemed a duplicate packet. Such a timeout period would allow a less restrictive approach to forwarding packets that might be desirable in some instances.

Although the present invention and its advantages have been described in detail, it should be understood that various changes, substitutions and alterations could be made herein without departing from the spirit and scope of the invention as defined by the appended claims.

1. A method for processing IP address messages comprising the steps of:
receiving by a relay agent a first message from a client over a network wherein the first message has a first request message identifier;
comparing the first message identifier to an at least one stored identifier; and
forwarding the first message if the first message identifier does not match the at least one stored identifier.

2. The method of claim 1 wherein the relay agent is operationally coupled to a bridge.

3. The method of claim 1 wherein the relay agent is operationally coupled to a router.

4. The method of claim 1 wherein the first message is a Dynamic Host Control Protocol (DHCP) request packet.

5. The method of claim 1 further comprising the step of storing the first message identifier as at least one stored identifier.

6. The method of claim 1 wherein the first message is received by the relay agent over a plurality of interfaces.

7. The method of claim 1 wherein the first message is a Dynamic Host Control Protocol (DHCP) discover packet.

8. The method of claim 1 further comprising the step of discarding the first message if the first message identifier matches one or more of the at least one stored identifier.

9. The method of claim 1 further comprising the step of deleting one or more of the at least one stored identifier after a timeout period.

10. A system for processing DCHP packets comprising:
an interface for receiving a DHCP packet wherein the DHCP packet originates from a client, the DHCP packet is sent over a first network, and the DHCP packet has a first identifier;
a comparator for determining whether the first identifier matches at least one stored identifier; and
a cache for storing the first identifier as at least one stored identifier;
a transmitter for sending the DHCP packet over a second network if the first identifier does not match the at least one stored identifier.

11. The system of claim 10 wherein the DHCP packet is a DHCP discover packet.

12. The system of claim 10 wherein the DHCP packet is a DHCP request packet.

13. The system of claim 10 wherein the first network and the second network are subnetworks of a single network.

14. A system for processing IP address messages comprising:
circuitry for receiving a message over a first interface wherein the message has a message identifier;
circuitry for comparing the message identifier to at least one stored identifier;
circuitry for storing the message identifier as at least one stored identifier if the message identifier does not match at least one stored identifier;
circuitry for forwarding the message over a second interface if the message identifier does not match at least one stored identifier;

14. The system of claim 14 wherein the message is a DHCP request packet.

15. The system of claim 14 wherein the message is a DHCP discover packet.

16. The system of claim 14 further comprising circuitry for deleting one or more of the at least one stored identifier after a timeout period.

17. The system of claim 14 further comprising circuitry for flagging one or more of the at least one stored identifier after a timeout period.

18. The system of claim 14 further comprising circuitry for receiving the message over a third interface.
